(19) United States
(12) Patent Application Publication
(10) Pub. No.: US 2010/0156081 A1
(43) Pub. Date: Jun. 24, 2010

(54) IMPACT ABSORBING DEVICE FOR STEERING COLUMN OF VEHICLE

(75) Inventor: Jun Yong Min, Seongnam (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/687,500

(22) Filed: Jan. 14, 2010

Related U.S. Application Data
(63) Continuation-in-part of application No. 11/298,645, filed on Dec. 8, 2005, now abandoned.

(30) Foreign Application Priority Data
Oct. 6, 2005 (KR) 10-2005-0093965

(51) Int. Cl. B62D 1/11

(52) U.S. Cl. 280/777

(57) ABSTRACT

An impact absorbing device for a steering column of a vehicle including a bearing and a pipe in addition to a mounting bracket, the structure of the mounting bracket being modified so that a bearing member and a bolt are installed thereto, wherein the impact transfer to a shaft through a steering shaft in the case of collision of a vehicle can be prevented since capsules and the bolt are broken, thereby preventing excessive impact and interference with peripheral parts.

### CROSS-REFERENCE TO RELATED APPLICATION

This application is a continuation in part of U.S. application Ser. No. 11/298,645, filed Dec. 8, 2005, which claims priority to and the benefit of Korean Patent Application 10-2005-0093965 filed in the Korean Intellectual Property Office on Oct. 6, 2005, the entire content of both applications incorporated herein by reference.

### FIELD OF THE INVENTION

The present invention relates to an impact absorbing device for a steering column of a vehicle, and more particularly to an impact absorbing device for a steering column of a vehicle capable of preventing an excessive impact being applied to a steering column in the case of a vehicle collision and of preventing a steering column is from interfering with surrounding parts.

### BACKGROUND

It is known that in the event of a vehicle frontal collision, either the upper body of the driver is inclined forward and collides with a steering wheel, or a jacket tube, to which the steering wheel is mounted, is pushed upward toward the driver and then collides with the upper body of the driver. Therefore, a conventional steering column to which a steering wheel is mounted has a structure for absorbing an impact applied thereto.

As shown in FIG. 1, a conventional steering column includes a steering shaft 1 having a steering wheel at one end thereof and having an engaging portion 6 engaged with a universal joint at the other end thereof, a jacket tube 2 separated from the outer peripheral surface of the steering shaft 1, a friction tube 3 installed between the steering shaft 1 and a jacket tube 2 so as to be axially moved in case a vehicle collision occurs, a mounting bracket 4 mounted to the jacket tube 2 and to be engaged with the vehicle body, and capsules 5 being installed on both sides of the mounting bracket 4 so as to be broken in the case of a vehicle collision.

In the event of a vehicle frontal collision, the capsules 5 installed on the mounting bracket 4 are broken so that the friction tube 3 can be axially moved and absorb an impact energy by way of friction.

However, according to the above-mentioned structure of a conventional steering column, the impact from the vehicle body is directly transferred to the jacket tube 2 by the frictional movement of the friction tube 3. That is, the impact energy is excessively distributed to the entire steering column in the case of a collision, due to the wide distribution of the collapse load by the frictional tube. Thus the impact energy is not absorbed but is directly transferred to the driver, thereby causing serious damage to the is driver.

Further, since peripheral parts such as brake and accelerator pedals are arranged around the steering column, there may exist some interference between the steering column and the peripheral parts during the steering column collapse.

The information set forth in this Background of the Invention section is only for enhancement of understanding of the invention and should not be taken as an acknowledgement or any form of suggestion that this information forms the prior art that is already known to a person skilled in the art.

### SUMMARY OF THE INVENTION

In one aspect, an impact absorbing device for a steering column of a vehicle is provided which includes a bearing member and a pipe, in which capsules and a bolt are broken in the event of a vehicle collision. This is accomplished by modifying the structure of a mounting bracket for a jacket tube so that the bearing member and the bolt is installed in the mounting bracket and the pipe is configured to be slid along the main body of the steering column, thereby preventing excessive impact and interference with the peripheral parts.

According to a preferred embodiment of the present invention, there is provided an impact absorbing device for a steering column of a vehicle, which comprises: a jacket tube separated from the outer peripheral surface of a steering shaft by a predetermined interval, at one end of which a steering wheel is installed ; a mounting bracket for attaching the jacket tube to the body of a vehicle, the mounting bracket having a bolt and a moving hole on one end thereof, and having a mounting portion and curling plates for absorbing an impact on the opposite end thereof; a pipe movably installed between the steering shaft and the jacket tube; capsules installed at both ends of the mounting portion, the capsules being configured to be separated from the mounting portion when an impact occurs; and a bearing member mounted to a lower portion of the steering shaft and engaged with the mounting bracket.

According to an embodiment of the present invention, the impact absorbing device further comprises: a connecting member having a nut hole to be engaged with the bolt of the mounting bracket.

According to an embodiment of the present invention, the pipe is moved by the movement of the steering shaft.

According to an embodiment of the present invention, the pipe is separated from the jacket tube by a predetermined interval.

According to an embodiment of the present invention, the bearing member is not moved in the longitudinal direction of the steering shaft but is configured to rotate the steering shaft.

According to an embodiment of the present invention, the connecting member is engaged with the mounting bracket by the bolt which is configured to be broken when an impact occurs.

According to an embodiment of the present invention, the material for the capsules and the bolt is a synthetic resin.

According to an embodiment of the present invention, the curling plates and the bolt are configured to be simultaneously broken in the event of a vehicle collision.

The invention also includes vehicles particularly motor vehicles such as automobiles, trucks and the like that comprise an impact absorbing device for a steering column as described herein.

It is understood that the term “vehicle” or “Vehicular” or other similar terms as used herein is inclusive of motor vehicles in general such as passenger automobiles, buses, trucks, various commercial vehicles, watercraft including a variety of boats, aircraft, and the like.

Other aspects of the invention are discussed below.

### BRIEF DESCRIPTION OF THE DRAWINGS

The above and other objects, features and advantages of the present invention will be more apparent from the following detailed description taken in conjunction with the accompanying drawings, in which:

FIG. 1 is a view for showing a conventional impact absorbing device for a steering column of a vehicle;

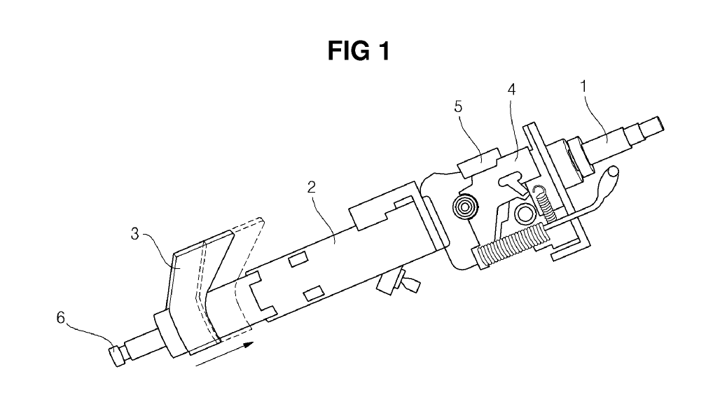

FIG. 2 is a view for showing an impact absorbing device for a steering column of a vehicle according to the present invention;

FIG. 3 is an enlarged view of portion A of FIG. 2, which shows a state of a vehicle after a collision;

FIG. 4 is a rear view for showing an impact absorbing device for a steering column of a vehicle according to the present invention;

FIG. 5 is a exploded view drawing for showing a mounting bracket, capsules, and curling plates; and

FIG. 6 is a cross-sectional view for showing a steering shaft, a jacket tube, a pipe, and a bearing member combined altogether.

### DETAILED DESCRIPTION OF THE PREFERRED EMBODIMENTS

As discussed above, an impact absorbing device for a steering column of a vehicle is provided which in preferred aspects comprises: (1) a jacket tube which is is preferably separated from the outer peripheral surface of a steering shaft by a predetermined interval, and preferably in which a steering wheel is installed at one end of the jacket tube; (2) a mounting bracket for attaching the jacket tube to the body of a vehicle and configured to absorb impact; (3) a pipe movably installed between the steering shaft and the jacket tube; and (4) capsules which are configured to be separated from the mounting bracket when an impact occurs. Preferred embodiments of the device may also include a bearing member mounted to a lower portion of the steering shaft and engaged with the mounting bracket.

An impact absorbing device for a steering column of a vehicle according to a preferred embodiment of the present invention will be now described with reference to the accompanying drawings.

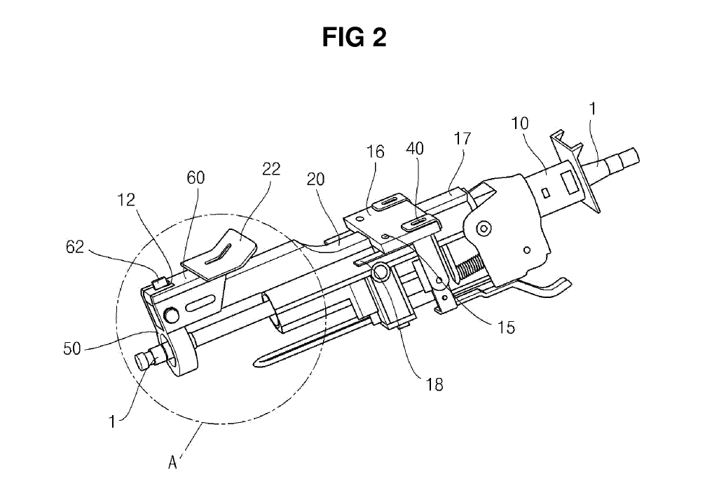

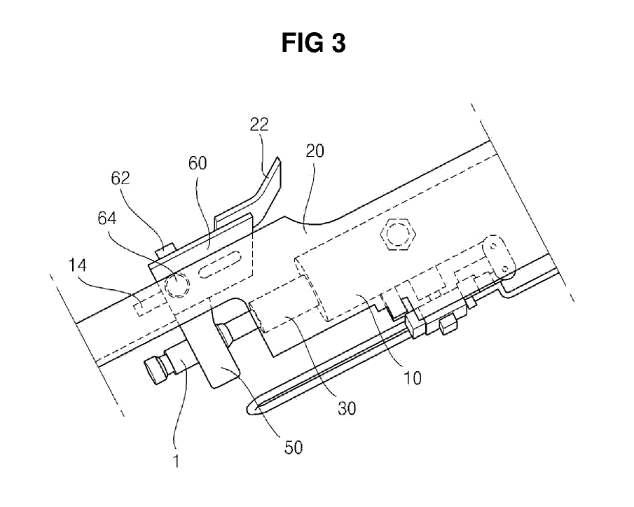

FIG. 2 is a view for showing an impact absorbing device of a steering column according to the present invention and FIG. 3 is an enlarged view of portion A of FIG. 2, which shows a state of a vehicle after a collision. As can be seen in FIGS. 2 and 3, the absorbing device includes a jacket tube 10, a mounting bracket 20, a pipe 30, capsules 40, a bearing member 50, and a connecting member 60.

The jacket tube 10 has a hollow pipe-like shape and is separated from the outer peripheral surface of a steering shaft 1 by a predetermined interval.

A steering wheel to be rotated by the operation of a driver is installed at one end of the jacket tube 10. The mounting bracket 20 is mounted to the other end of the jacket tube 10, so as to surround the outer peripheral surface of the jacket tube 10. The jacket tube 10 is engaged with the vehicle body via a mounting piece 22 provided at an lower portion of the mounting bracket 20.

A nut hole 12 with which a bolt 62, which is configured to be broken when an impact occurs, is engaged is provided on one side of the connecting member 60. A is moving hole 14, to which the bearing member 50 is movably mounted so as to move in the longitudinal direction of the moving hole 14, is provided on one side of the mounting bracket 20. Also, a mounting portion 16, having the capsules 40 on both sides thereof, and curling plates 18 which are installed on both sides of the mounting bracket 20 under the mounting portion 16 to absorb an impact, are provided on the other side of the mounting bracket 20.

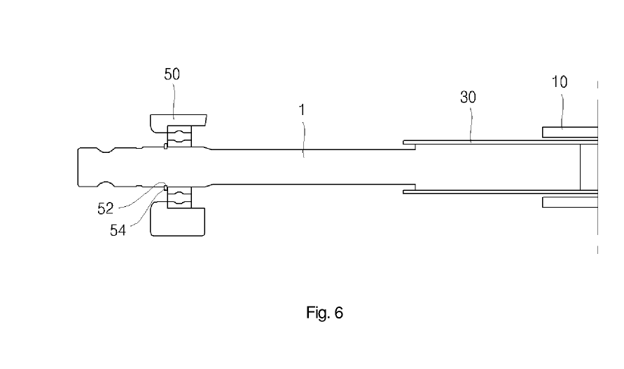

The pipe 30 is engaged with the steering shaft 1 such that the steering shaft 1 may be moved in its longitudinal direction in the interior of the pipe 30, and is movably installed to the jacket tube 10. The pipe 30 is radially separated from the jacket tube 10 by a predetermined interval and is supported by the capsules 40 and the bolt 62 in such a manner that it cannot be moved longitudinally except for when an impact occurs. Further, as shown in FIGS. 3 and 6, the pipe 30 is engaged with the steering shaft 1 such that it moves together with the steering shaft 1 when the steering column collapses upon a vehicle impact.

The pipe 30 is configured to protrude beyond the jacket tube 10 together with the steering shaft 1 in a normal state, and is configured to move back and forth, or enters into and withdraws from the interior of the jacket tube 10 along a longitudinal direction thereof when an impact is applied to the vehicle, as shown in FIG. 3.

It is preferable that the capsules 40 provided at the mounting portion 16 of the mounting bracket 20 are mounted so as to escape from the mounting portion 16 when to an external force is applied to the vehicle body upon an impact, and are positioned opposite an adhering portion 17.

The capsules 40 are installed at both ends of the mounting portion 16, which is installed on one side of the mounting bracket 20, and are connected to the vehicle body by the nut 24 so that the mounting portion 16 may be escaped from the capsules 40 upon an impact.

It is preferable that the material of the capsules 40 is a synthetic resin.

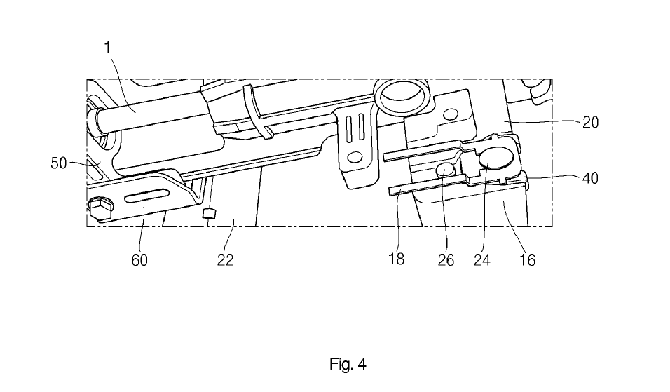

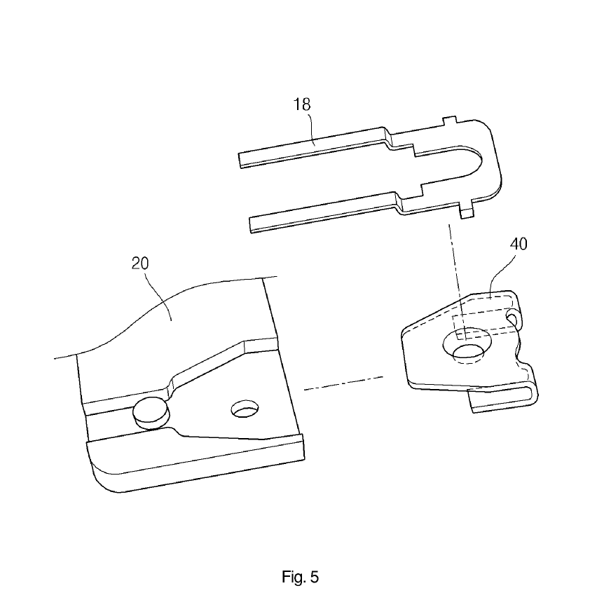

As can be seen in FIGS. 4 and 5, the curling plates 18 is connected to the capsules 40. The mounting portion 16 is also connected to the curling plates 18 by the nut 24 and the curling plate 18 is connected to the vehicle body by the nut 24. When impact energy is transferred through the mounting bracket 20, the curling plates 18 are torn by the rivet 26.

If the curling plates 18 are broken by an external force upon an impact, the impact is firstly absorbed by the withdrawal of the pipe 30 and the residual impact is then absorbed by the resistive sliding of the steering shaft 1 and the pipe 30. Accordingly, the protrusion of the jacket tube 10 toward the driver is effectively prevented and the impact of the steering wheel onto the driver's upper body is reduced.

Since the impact absorbing device of the steering column according to the present invention has a dual breakage structure in which the curling plates 18 and the bolt 62 are broken simultaneously by an external force upon an impact, the impact may be effectively absorbed.

It is preferable that the material of the bolt 62 is the same synthetic resin as that of the capsules 40.

Further, if impact energy is transferred through the steering shaft 1 and the pipe 30, the curling plates 18 are curled and then torn in the direction in which the impact to proceeds and thus the impact absorbing capacity is doubled, thereby remarkably decreasing the impact transferred to the driver through the steering wheel.

The bearing member 50 is mounted to the lower portion of the steering shaft 1, and is securely engaged to the steering shaft 1 by inserting a fixing piece 54 into a fixing recess 52 formed on the steering shaft 1. Also, the upper part of the bearing member 50 is fixed to the connecting member 60 and is movably engaged with the mounting bracket 20 via the moving hole 14.

Further, the bearing member 50 is configured not to be moved in the longitudinal direction of the steering shaft 1, but is rather configured to rotate the steering shaft 1, thereby enabling free rotation of the steering wheel and preventing the steering wheel from protruding or moving toward the driver.

Both ends of the connecting member 60 are bent to surround a portion of the mounting bracket 20 and one end of the bearing member 50, and a penetration hole (not shown) for mounting a movement pin 64 is formed at one end of each bent portion.

Here, the nut hole 12 of the connecting member 60 is engaged with the mounting bracket 20 by the bolt 62 configured to be broken in the event of a vehicle collision.

The connecting member 60 is located at the lowest portion of the mounting bracket 20 in a normal state, and when the bolt 62 is broken upon an impact, the mounting bracket 20 is moved downward relative to the connecting member 60, within the range that the movement pin 64 can be moved in the moving hole 14. It seems like that the connecting member 60 is moved upward relative to the mounting bracket 20.

If the connecting member 60 is relatively moved, the steering shaft 1 engaged with the connecting member 60 by the bearing member 50 is moved accordingly and thus the pipe 30 is also moved simultaneously, performing the impact absorption of the steering column.

Hereinafter, the operation of the impact absorbing device of the steering column according to the present invention will be described.

When the vehicle travels normally, the steering wheel is rotated by manipulation of a driver to determine the direction in which the vehicle travels. Then, if the vehicle comes into a collision and is subjected to an impact, collision energy is transferred to the steering shaft 1.

Since the curling plates 18 connected to the jacket tube 10 through the capsules 40 and the mounting bracket 20 and the bolt 62 connected to the jacket tube 10 through the mounting bracket 20 are broken before the collision energy transferred to the steering shaft 1 is further transferred to the jacket tube 10, the collision energy of the jacket tube 10 is not transferred but rather is absorbed.

When the curling plates 18 and the bolt 62 are broken, the steering shaft 1 starts to slide along the moving hole 14 formed on one side of the mounting bracket 20.

Then, the pipe 30 is slid along with the steering shaft 1, performing the impact absorption of the steering column.

Therefore, since the collision energy resulting from an external impact is absorbed by the breakage of the curling plates 18 and the bolt 62, as well as the slide of the steering shaft 1 and the pipe 30, so that the collision energy is not transferred to the jacket tube 10, the damage of the driver due to the steering wheel is reduced upon a vehicle collision.

In the impact absorbing device for a steering column of a vehicle according to the present invention, the breakage and the slide occur in combination upon a vehicle collision, thereby preventing the transfer of impact to the jacket tube through the steering shaft. Therefore, the present invention can effectively prevent the excessive impact and injury to the driver, and can prevent interference with surrounding parts such as a brake to pedal or an accelerator pedal.

Although an embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An impact absorbing device for a steering column of a vehicle, which comprises:
a jacket tube separated from an outer peripheral surface of a steering shaft by a predetermined interval, in which a steering wheel is installed at one end of the jacket tube;
a mounting bracket for attaching the jacket tube to a body of a vehicle, the mounting bracket having a bolt and a moving hole on one end thereof, and having a mounting portion and curling plates for absorbing an impact on the opposite end thereof;
a pipe movably installed between the steering shaft and the jacket tube;
capsules installed at both ends of a mounting portion of the mounting bracket, the capsules configured to be separated from the mounting portion when an impact occurs; and
is a bearing member mounted to a lower portion of the steering shaft and engaged with the mounting bracket.

2. An impact absorbing device according to claim 1, further comprising:
a connecting member having a nut hole to be engaged with the bolt of the mounting bracket.

3. An impact absorbing device according to claim 1, wherein the pipe is moved by a movement of the steering shaft.

4. An impact absorbing device according to claim 1, wherein the pipe is separated from the jacket tube by a predetermined interval.

5. An impact absorbing device according to claim 1, wherein the bearing member is not moved in a longitudinal direction of the steering shaft but is configured to rotate the steering shaft.

6. An impact absorbing device according to claim 1, wherein the connecting member is engaged with the mounting bracket by the bolt which is configured to be broken when an impact occurs.

7. An impact absorbing device according to claim 6, wherein the material of the capsules and the bolt is a synthetic resin.

8. An impact absorbing device according to claim 6, wherein the curling plates is and the bolt are configured to be simultaneously broken in the event of a vehicle collision.

9. A vehicle comprising the impact absorbing device of claim 1.

10. An impact absorbing device for a steering column of a vehicle, which comprises:
a jacket tube;
a mounting bracket for attaching the jacket tube to a body of a vehicle and configured to absorb impact;
a pipe movably installed between a steering shaft and the jacket tube;
capsules which are installed at the mounting bracket, the capsules being configured to be separated from the mounting bracket when an impact occurs; and
a bearing member mounted to a lower portion of the steering shaft and engaged with the mounting bracket.

11. A vehicle comprising the impact absorbing device of claim 10.
